(19) United States
(12) Patent Application Publication
(10) Pub. No.: US 2015/0174847 A1
(43) Pub. Date: Jun. 25, 2015

(54) WEB LAYOUT FOR CARTON BLANKS

(71) Applicant: Graphic Packaging International, Inc., Atlanta, GA (US)

(72) Inventor: Kevin Thum, Spring City, PA (US)

(21) Appl. No.: 14/576,606

(22) Filed: Dec. 19, 2014

Related U.S. Application Data
(60) Provisional application No. 61/964,007, filed on Dec. 20, 2013.

(51) Int. Cl. B31B 1/02; B65D 5/42; B31B 1/26

(52) U.S. Cl. CPC B31B 1/02; B31B 1/26; B65D 5/4266

(57) ABSTRACT

A web of material for forming at least one carton for containing a product. The web comprises a grain direction and at least one blank comprising a plurality of panels. The plurality of panels comprises at least a first panel foldably connected to a second panel along a fold line. The fold line extends in an oblique direction with respect to the grain direction of the web.

### CROSS REFERENCE TO RELATED APPLICATIONS

This application claims the benefit of U.S. Provisional Patent Application No. 61/964,007, filed Dec. 20, 2013.

### INCORPORATION BY REFERENCE

The disclosure of U.S. Provisional Patent Application No. 61/964,007, which was filed on Dec. 20, 2013, is hereby incorporated by reference for all purposes as if presented herein in its entirety.

### BACKGROUND OF THE DISCLOSURE

The present disclosure generally relates to cartons for holding and carrying contents, the blanks for forming the cartons, and webs comprising one or more blanks.

### SUMMARY OF THE DISCLOSURE

In general, one aspect of the disclosure is directed to a web of material for forming at least one carton for holding at least one article. The web can comprise a grain direction and at least one blank at least partially defined in the web. The at least one blank can comprise a plurality of panels and can have at least a longitudinal direction that extends in an oblique direction with respect to the grain direction of the web.

In another aspect, the disclosure is generally directed to a method of forming a web of material. The method can comprise obtaining a web of material comprising a grain direction and forming at least one blank in the web. The at least one blank can comprise a plurality of panels and can have at least a longitudinal direction that extends in an oblique direction with respect to the grain direction of the web.

In another aspect, the disclosure is generally directed to a method of forming at least one carton for holding at least one article. The method can comprise obtaining a web of material comprising a grain direction and forming at least one blank in the web. The at least one blank can comprise a plurality of panels and can have at least a longitudinal direction that extends in an oblique direction with respect to the grain direction of the web. The method further can comprise separating the at least one blank from the web and forming the at least one carton from the at least one blank.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of a web with a plurality of blanks used to form respective cartons in accordance with a first exemplary embodiment of the disclosure.

FIG. 2 is a plan view of a blank of FIG. 1.

FIG. 3 is an isometric schematic view of a carton formed from the blank of FIG. 2.

FIG. 4 is a plan view of a web with a plurality of blanks used to form respective cartons in accordance with a second exemplary embodiment of the disclosure.

FIG. 5 is a plan view of a blank of FIG. 4.

FIG. 6 is an isometric schematic view of a carton formed from the blank of FIG. 5.

Corresponding parts are designated by corresponding reference numbers throughout the drawings.

### DETAILED DESCRIPTION OF THE EXEMPLARY EMBODIMENTS

The present disclosure generally relates to webs of material with blanks formed therein for forming cartons that contain articles such as containers, portion packs, filter packs, bottles, cans, etc. Alternatively, the cartons can contain articles such as liquids, powders, other flowable materials, etc. The articles can be used for packaging food and beverage products, for example. The articles can be made from materials suitable in composition for packaging the particular food or beverage item, and the materials include, but are not limited to, aluminum and/or other metals; glass; plastics such as PET, LDPE, LLDPE, HDPE, PP, PS, PVC, EVOH, and Nylon; and the like, or any combination thereof.

Cartons according to the present disclosure can accommodate articles of any shape. For the purpose of illustration and not for the purpose of limiting the scope of the disclosure, the following detailed description describes portion containers (e.g., plastic portion cups) as disposed within the carton embodiments. In this specification, the terms “inner,” “interior,” “outer,” “exterior,” “lower,” “bottom,” “upper,” and “top” indicate orientations determined in relation to fully erected and upright cartons.

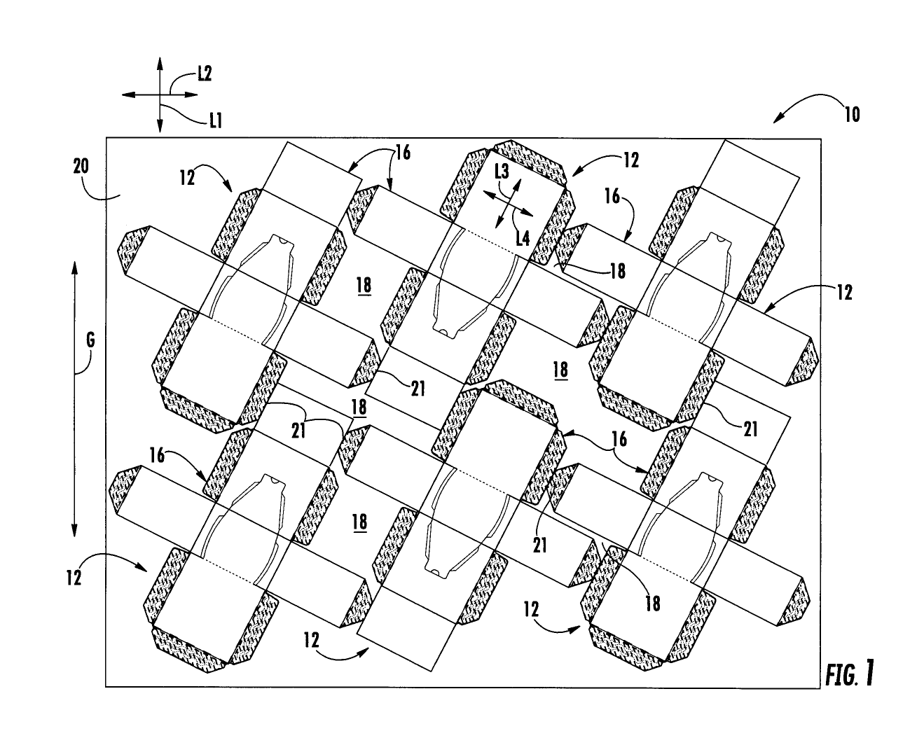

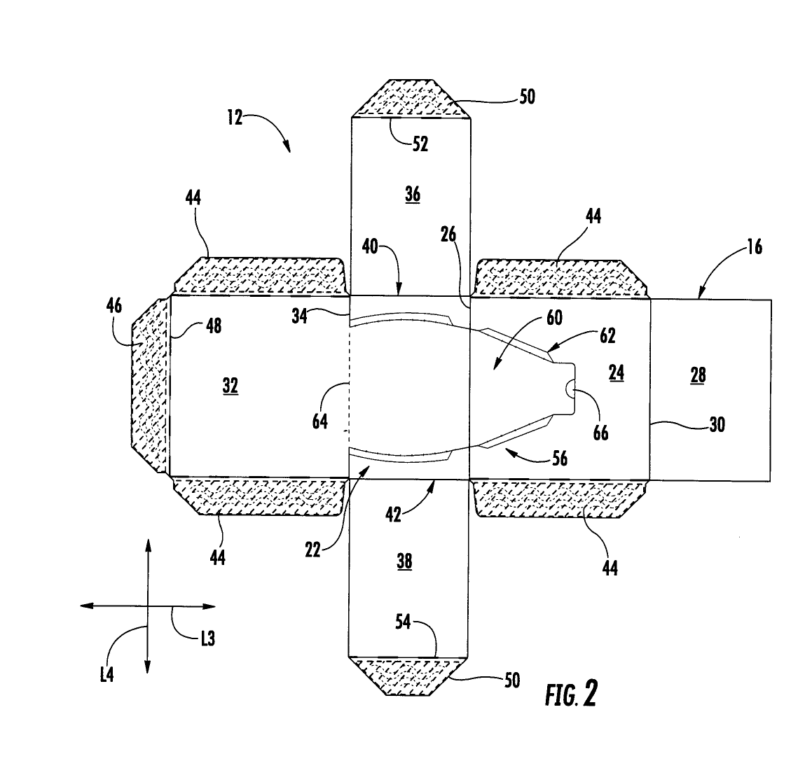

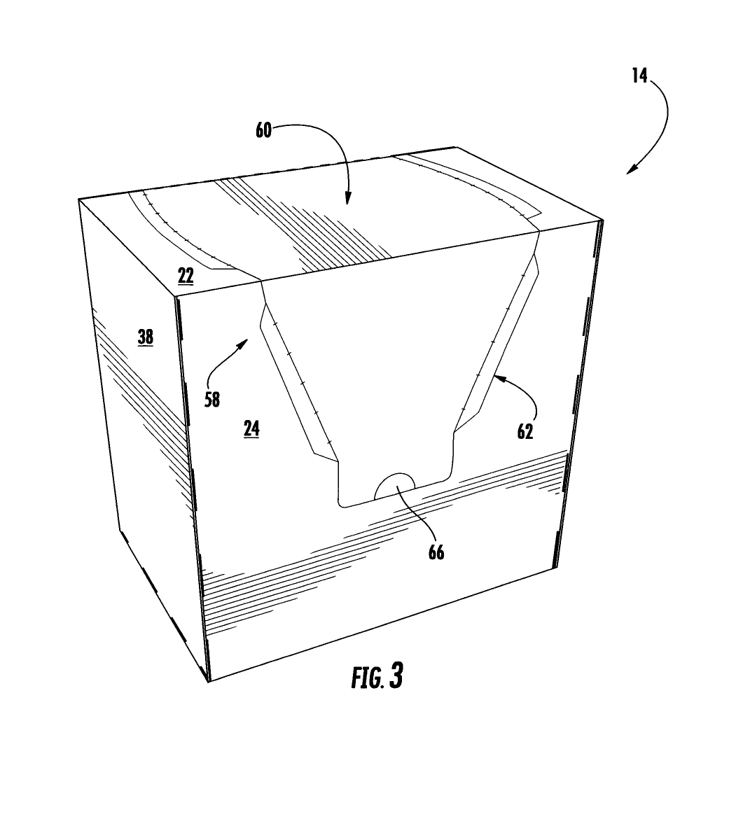

FIG. 1 is a plan view of a web 10 with a plurality of blanks 12 disposed in the web 10. Each of the blanks 12 (FIG. 2) can be used to form a carton 14 (FIG. 3) according to the exemplary embodiment of the disclosure. The carton 14 can be used to hold articles (not shown) such as a plurality of portion cups, filter packs, or any other suitable article or product within an interior (not shown) of the carton. In the illustrated embodiment, the carton 14 is sized to contain several containers, but it is understood that the carton 14 may be sized and shaped to hold contents of a different quantity.

The web 10 has a first direction L1 and a second direction L2. In one embodiment, the web 10 can be cut from a roll of material, and the first direction L1 can be along the direction of the unrolling of the web and the second direction L2 can correspond to the width of the roll. In the illustrated embodiment, the grain direction G generally can be parallel to the first direction L1. As shown in FIG. 1, the web 10 is sized to include six blanks 12 in a 2×3 arrangement, but it is understood that the web 10 and the blanks 12 may be sized and shaped so that a different or same quantity of blanks can be included on the web in different row/column arrangements (e.g., 1×6, 3×6, 6×2, 3×5, 4×5, 2×9, 2×6, 4×4, etc.). The borders 16 (e.g., the outer edges) of the blanks 12 can be cut, weakened, or otherwise formed into the web 10 so that the blanks can be separated from the remainder of the web and from adjacent blanks. Breakaway portions 18 of the web 10 are interspersed with the blanks 12 and a marginal portion 20 of the web can extend around at least a portion of the array of blanks. In the illustrated embodiment, the blanks 12 can be separable from one another along cut lines 21, which can extend along the respective borders 16 of two or more adjacent blanks 12.

As shown in FIGS. 1 and 3, each of the blanks 12 has a longitudinal axis L3 extending generally in the direction of the length of the blank and a lateral axis L4 extending generally in the direction of the width of the blank. In the illustrated embodiment, the longitudinal axis L3 and the lateral axis L4 of each blank are rotated (e.g., oblique) with respect to the respective first and second directions L1, L2 of the web 10. In one embodiment, the axes L3, L4 are rotated approximately 63 degrees with respect to the directions L1, L2. For example, in FIG. 1, the angle between the axis L3 and the direction L2 is approximately 63 degrees. Alternatively, the axes L3, L4 could be rotated in the range of approximately 45 degrees to approximately 65 degrees or any other suitable angle.

As shown in FIG. 2, the blank 12 includes a top panel 22 foldably connected to a first side panel 24 at a lateral fold line 26. A bottom panel 28 is foldably connected to the first side panel 24 at a lateral fold line 30. A second side panel 32 is foldably connected to top panel 22 at a lateral fold line 34. A first end panel 36 and a second end panel 38 are foldably connected to the top panel 22 at respective longitudinal fold lines 40, 42.

The side panels 24, 32 are foldably connected to respective side flaps 44 along the longitudinal fold lines 40, 42. The side panel 32 is foldably connected to a bottom end flap 46 along a lateral fold line 48. The end panels 36, 38 are foldably connected to respective bottom end flaps 50 along respective longitudinal fold lines 52, 54. When the carton 14 is erected, the side flaps 44 are attached (e.g., glued) to the interior surfaces of the end panels 36, 38, and the bottom end flaps 46, 50 are attached (e.g., glued) to the interior surface of the bottom panel 28. In accordance with an alternative embodiment of the present disclosure, different panel and flap arrangements can be used for at least partially erecting the carton 14.

In one embodiment, the blanks 10 can include dispenser features 56 and/or handle features (not shown). The dispenser features 56 can form a dispenser 58 in the carton 14 (FIG. 2) and can include a dispenser panel 60 extending in the top panel 22 and the side panel 24. The dispenser panel 60 can be defined by a tear line 62 so that the dispenser panel 60 can be at least partially separated from the carton 14 to provide access to the containers in the interior of the carton 14. As shown in FIG. 2, the dispenser panel can be foldably connected to the side panel 32 along a lateral fold line 64. An opening feature 66 can be included in the dispenser panel 60, the side panels 24, 32, and/or the top panel 22 for helping to open the dispenser 58. The dispenser features 56 and/or the dispenser 58 could be omitted or could be alternatively shaped, arranged, positioned, and/or configured without departing from the disclosure. For example, the dispenser panel 60 and the tear line 62 could extend in more or fewer of the panels and/or flaps of the blank 12. Further, the fold line 64 could be disposed in the side panel 32, in the top panel 22, or elsewhere in the blank 12 and/or could be replaced by a cut or tear line. Additionally, the tear line 62 could be a cut line or another other form of weakening.

In the illustrated embodiment, the end panels 36, 38 are relatively long in the lateral direction L4 relative to the lateral width of the side panels 24, 32. This configuration could reduce or inhibit nesting of the blanks 12 if their axes L3, L4 were aligned with or at 90 degrees to the directions L1, L2 of the web 10. Angling the blanks 12 in the web 10 allows the blanks to be nested as shown in FIG. 1, which can help reduce the amount of the web material that is wasted (e.g., breakaway portions 18 and/or marginal portion 20). Additionally, more blanks 12 may be included on each web 10. For example, a web with blanks that are aligned with the directions L1, L2 might be able to fit only four blanks in contrast to the six blanks 12 included in the web 10. In one embodiment, several webs 10 could be cut from a roll and stacked on a shipping pallet for shipping. Accordingly, including more blanks 12 on each web 10 allows more blanks to be included on each pallet in shipping, which can help reduce transportation costs. Further, in one embodiment, the angled orientation of the blanks on the web can help reduce ghosting of the printed material on the blanks.

In the illustrated embodiment, the blanks 12 can be formed in the web 10 (e.g., the fold lines, cut lines, tear lines, and/or other features could be formed in the web 10) so that the panels 22, 24, 28, 32, 36, 38 and/or the flaps 44, 46, 50 of one blank 12 can be separable from one or more panels and/or flaps of a respectively adjacent blank along the cut lines 21. The blanks 12 can be separated from one another and from the breakaway portions 18 and the marginal portion 20 for forming the respective cartons 14. For example, the blanks 12 can be separated from one another along the cut lines 21 and can be separated from the breakaway portions 18 and the marginal portion 20 along the remainders of the respective borders 16. Alternatively, the breakaway portions 18 could be separated (e.g., punched out) from between the respective blanks 12 and the marginal portion 20 can be separated from the blanks 12 before the blanks 12 are separated from one another. The blanks 12 could be otherwise formed and/or separated from the web 10 without departing from the disclosure. For example, one or more of the fold lines and/or tear lines and/or other features of the blanks 12 could be formed before and/or after the web 10 is cut from a roll. In another example, one or more of the blank features could be formed before or after the blanks 12 are separated from the web 10 and/or one another.

In one embodiment, the carton 14 can be formed from one of the blanks 12 by folding the panels 22, 24, 32, 36, 38 along the respective fold lines 26, 34, 40, 42 around an interior of the carton 14. The side flaps 44 can be folded along the longitudinal fold lines 40, 42 and glued to the interior surfaces of the respective end panels 36, 38. One or more articles (not shown) can be loaded into the interior of the carton 14 (e.g., through an open bottom of the carton). The bottom end flaps 46, 50 and the bottom panel 28 can be folded along respective fold lines 48, 52, 54, 30, and the bottom panel 28 can be glued to the bottom end flaps 46, 50 to close the bottom of the carton 14 (FIG. 3). Alternatively, different forming and/or loading steps could be used without departing from the disclosure.

The web 10, the blanks 12, and/or the cartons 14 could be omitted or could be alternatively shaped, arranged, positioned, and/or configured without departing from the disclosure.

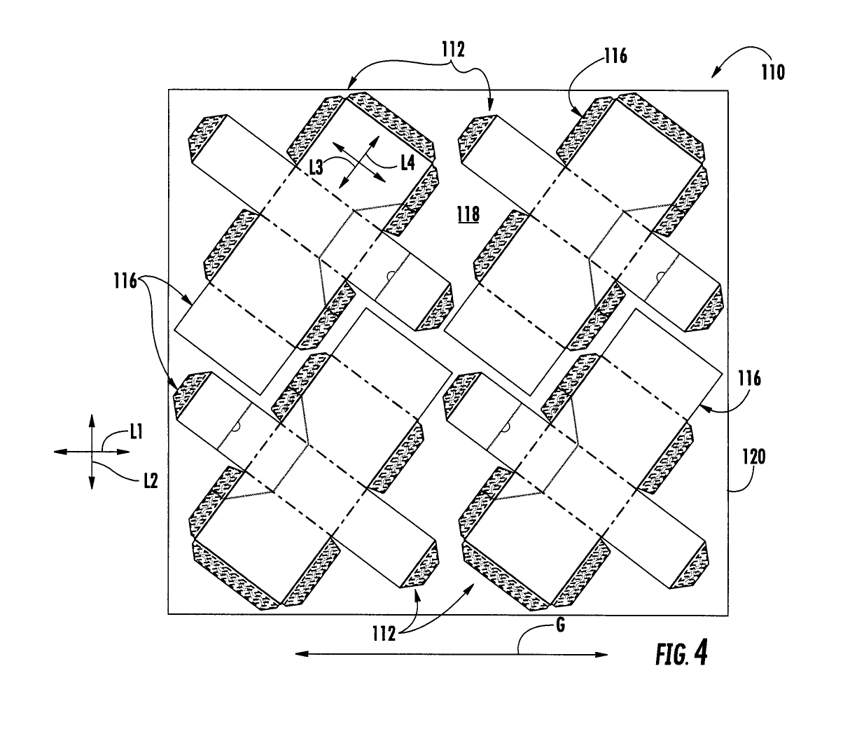

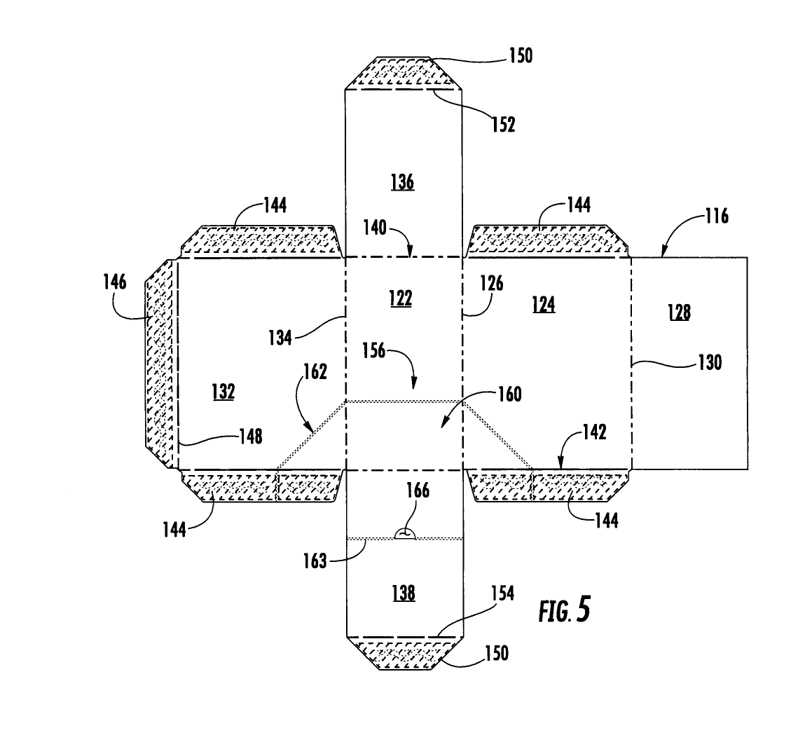

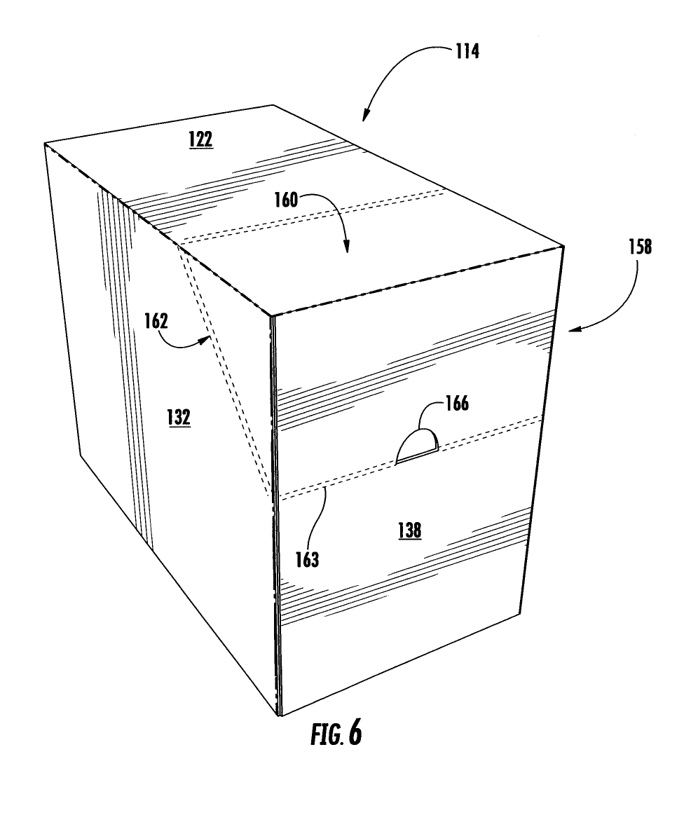

FIG. 4 is a plan view of a web 110 with a plurality of blanks 112 disposed in the web 110 according to a second embodiment of the disclosure. Each of the blanks 112 (FIG. 5) can be used to form a carton 114 (FIG. 6). The second embodiment is generally similar to the first embodiment, except for variations noted and variations that will be apparent to one of ordinary skill in the art. Accordingly, similar or identical features of the embodiments have been given like or similar reference numbers. In one embodiment, the blanks 112 generally can be larger than the blanks 12 so that the carton 114 generally can contain more articles than the carton 14. In the second embodiment, the longitudinal axis L3 and the lateral axis L4 can be rotated (e.g., oblique) with respect to the respective first and second directions L1, L2 of the web 10. In one embodiment, the axes L3, L4 are rotated approximately 53 degrees with respect to the directions L1, L2. For example, in FIG. 4, the angle between the axis L4 and the direction L1 is approximately 53 degrees. Alternatively, the axes L3, L4 could be rotated in the range of approximately 45 degrees to approximately 65 degrees or any other suitable angle.

As shown in FIG. 5, the blank 112 can include a top panel 122 foldably connected to a first side panel 124 at a lateral fold line 126. A bottom panel 128 is foldably connected to the first side panel 124 at a lateral fold line 130. A second side panel 132 is foldably connected to top panel 122 at a lateral fold line 134. A first end panel 136 and a second end panel 138 are foldably connected to the top panel 122 at respective longitudinal fold lines 140, 142. The side panels 124, 132 are foldably connected to respective side flaps 144 along the longitudinal fold lines 140, 142. The side panel 132 is foldably connected to a bottom end flap 146 along a lateral fold line 148. The end panels 136, 138 are foldably connected to respective bottom end flaps 150 along respective longitudinal fold lines 152, 154. The panels, flaps, and/or fold lines can be generally similar to the features of the blank 12 in one embodiment. Alternatively, the blank 112 could be alternatively shaped, arranged, positioned, and/or configured without departing from the disclosure.

As shown in FIG. 5, the blank 112 can have different dispenser features 156 than the blank 12 for forming an alternative dispenser 158 in the carton 114 (FIG. 6). For example, the dispenser features 156 can include a dispenser panel 160 extending in the top panel 122, the side panels 124, 132, and the end panel 138. The dispenser panel 160 can be defined by tear lines 162 in the top panel 122 and the side panels 124, 132 and a tear line 163 in the end panel 138. An opening feature 166 (e.g., an opening) can be formed in the dispenser panel 160 in the end panel 138. The dispenser features 156 and/or the dispenser 158 could be omitted or could be alternatively shaped, arranged, positioned, and/or configured without departing from the disclosure.

As shown in FIG. 4, the blanks 112 can be formed in the web 110 similarly to the blanks 12 in the web 10. The blanks 112 generally are spaced apart from one another in the web 110 so that the remainder 118 of the web 110 is formed between and around the blanks 112. For example, the remainder 118 can include intermediate or breakaway areas between the blanks 112 and the marginal area of the web 110. The blanks 112 can be separated from the remainder 118 of the web 110 and can be formed into respective cartons 114 similarly to the blanks 12 and cartons 14 of the first embodiment. Alternatively, the blanks 112 and/or the cartons 114 could be otherwise formed without departing from the disclosure. The web 110, the blanks 112, and/or the cartons 114 could be alternatively shaped, arranged, positioned, and/or omitted without departing from the disclosure.

Any of the features of the various embodiments of the disclosure can be combined with, replaced by, or otherwise configured with other features of other embodiments of the disclosure without departing from the scope of this disclosure. Further, it is noted that the blanks, dispenser features, and/or other features of the various embodiments can be incorporated into a carton having any carton style or panel configuration. The carton styles and panel configurations described above are included by way of example.

The blanks according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the carton to function at least generally as described herein. The blanks can also be laminated or coated with one or more sheet-like materials at selected panels or panel sections.

In accordance with the above-described embodiments of the present disclosure, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed portion in the material along the desired line of weakness; a cut that extends partially into a material along the desired line of weakness, and/or a series of cuts that extend partially into and/or completely through the material along the desired line of weakness; and various combinations of these features.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

The above embodiments may be described as having one or more panels adhered together by glue during erection of the carton embodiments. The term “glue” is intended to encompass all manner of adhesives commonly used to secure carton panels in place.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments that are within the scope of the claims. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A web of material for forming at least one carton for holding at least one article, the web comprises:
a grain direction; and
at least one blank at least partially defined in the web, the at least one blank comprising a plurality of panels and having at least a longitudinal direction that extends in an oblique direction with respect to the grain direction of the web.

2. The web of claim 1, wherein the at least one blank comprises a plurality of blanks at least partially defined in the web.

3. The web of claim 1, wherein the at least one blank comprises at least a first blank and a second blank arranged on the web.

4. The web of claim 3, wherein the first blank and the second blank are at least partially separable along at least one cut line.

5. The web of claim 4, wherein the first blank and the second blank at least partially define a breakaway portion in the web therebetween.

6. The web of claim 3, wherein the first blank is at least partially spaced apart from the second blank to at least partially form a breakaway portion in the web.

7. The web of claim 3, wherein the first blank comprises a first plurality of panels and at least one first end flap, and the second blank comprises a second plurality of panels and at least one second end flap.

8. The web of claim 7, wherein the at least one first end flap is at least partially separable from the at least one second end flap along at least one cut line.

9. The web of claim 7, wherein at least one panel of the first plurality of panels is at least partially separable from the at least one second end flap along at least one cut line.

10. The web of claim 1, wherein the at least one blank comprises a plurality of panels for being disposed at least partially around an interior of the at least one carton formed from the at least one blank.

11. The web of claim 10, wherein the at least one blank further comprises at least one end flap foldably connected to a respective one of the panels, the at least one end flap being for at least partially closing an end of the at least one carton formed from the at least one blank.

12. The web of claim 11, wherein the at least one end flap is foldably connected to the respective one of the panels along a fold line, and the fold line is oblique with respect to the grain direction of the web.

13. A method of forming a web of material, the method comprising:
obtaining a web of material comprising a grain direction; and
forming at least one blank in the web so that the at least one blank comprises a plurality of panels and has at least a longitudinal direction that extends in an oblique direction with respect to the grain direction of the web.

14. The method of claim 13, wherein the forming the at least one blank comprises forming a plurality of blanks in the web.

15. The method of claim 13, wherein the forming the at least one blank comprises forming at least a first blank and a second blank in the web so that the first blank and the second blank are arranged on the web.

16. The method of claim 15, wherein the first blank and the second blank are at least partially separable along at least one cut line and at least partially define a breakaway portion in the web therebetween.

17. The method of claim 15, wherein the first blank is at least partially spaced apart from the second blank to at least partially form a breakaway portion in the web.

18. The method of claim 13, wherein the forming the at least one blank comprises forming a plurality of panels in the at least one blank.

19. The method of claim 18, wherein the forming the at least one blank further comprises forming at least one end flap foldably connected to a respective one of the panels.

20. A method of forming at least one carton for holding at least one article, the method comprising:
obtaining a web of material comprising a grain direction;
forming at least one blank in the web so that the at least one blank comprises a plurality of panels and has at least a longitudinal direction that extends in an oblique direction with respect to the grain direction of the web;
separating the at least one blank from the web; and
forming the at least one carton from the at least one blank.

21. The method of claim 20, wherein the forming the at least one blank comprises forming at least a first blank and a second blank in the web so that the first blank and the second blank are arranged on the web.

22. The method of claim 21, wherein the first blank and the second blank are at least partially separable along at least one cut line and at least partially define a breakaway portion in the web therebetween, the separating the at least one blank from the web comprising separating the first blank and the second blank from one another along the at least one cut line and separating the breakaway portion from the first blank and the second blank.

23. The method of claim 21, wherein the first blank is at least partially spaced apart from the second blank to at least partially form a breakaway portion in the web, the separating the at least one blank from the web comprising the breakaway portion from the first blank and the second blank.

24. The method of claim 20, wherein the forming the at least one blank comprises forming a plurality of panels in the at least one blank, and the forming the at least one carton comprises folding the panels of the plurality of panels with respect to one another to dispose the panels at least partially around an interior of the at least one carton.
